(19) United States
(12) Patent Application Publication
(10) Pub. No.: US 2025/0117398 A1
(43) Pub. Date: Apr. 10, 2025

(54) CROSS-DEVICE APPLICATION CONTROL METHOD AND ELECTRONIC DEVICE

(71) Applicant: HUAWEI TECHNOLOGIES CO., LTD., Shenzhen (CN)

(72) Inventor: Yonglin Xia, Dongguan (CN)

(73) Assignee: HUAWEI TECHNOLOGIES CO., LTD., Shenzhen (CN)

(21) Appl. No.: 18/983,291

(22) Filed: Dec. 16, 2024

Related U.S. Application Data
(63) Continuation of application No. PCT/CN2023/100200, filed on Jun. 14, 2023.

(30) Foreign Application Priority Data
Jun. 16, 2022 (CN) 202210682462.0

(51) Int. Cl. G06F 16/27

(52) U.S. Cl. CPC G06F 16/27

(57) ABSTRACT

A method includes a first device obtains application information of at least one first application of a second device from a first distributed database. The first distributed database is in the first device, the first distributed database is capable of data synchronization with a second distributed database, the second distributed database is in the second device, and the application information includes at least one of an application name, an application icon, and an application type. The first device displays a first interface. The first interface includes a second application of the second device, and the second application belongs to a subset of the first application.

### CROSS-REFERENCE TO RELATED APPLICATIONS

This application is a continuation of International Application No. PCT/CN2023/100200, filed on Jun. 14, 2023, which claims priority to Chinese Patent Application No. 202210682462.0, filed on Jun. 16, 2022. The disclosures of the aforementioned applications are hereby incorporated by reference in their entireties.

### TECHNICAL FIELD

This application relates to the field of electronic devices, and more specifically, to a cross-device application control method and an electronic device.

### BACKGROUND

With popularization of electronic devices, each user usually has a plurality of intelligent electronic devices at the same time, including a mobile phone, a tablet, a smart screen, a personal computer (PC), a smart speaker, a smart cockpit, and the like. Applications installed on these devices are different, and usage and control of applications on different devices are also different. For example, an application on a large screen needs to support control of a remote control, and an application on a mobile phone cannot be directly used on the large screen.

Currently, users are not satisfied with operating and managing applications on only a single device. However, in a distributed multi-device interaction scenario, cross-device application use is limited by a series of problems such as different systems, application adaptation, and data synchronization. For example, a user watches a video or plays a game on a mobile phone, and wants to continue to use such an application on a large screen after going back home. However, an application on the large screen usually does not have a corresponding mobile phone application, for example, a live broadcast application or a game application, and an operation cannot be performed on the large screen. For another example, a user wants to continue to listen to music of a mobile phone when driving a vehicle. However, because a corresponding application is not installed in a cockpit, the user needs to switch to the mobile phone to perform an application operation. Frequent device switching for application operation causes poor user experience.

Therefore, there is an urgent need for a cross-device application control method. According to the method, an existing application does not need to be modified, and a list of applications from different devices is supported in being displayed on a current device, so that a user can perform cross-device application management, and seamlessly use, on the current device, an application installed on another device.

### SUMMARY

This application provides a cross-device application control method and an electronic device. According to the method, an existing application does not need to be modified, and a list of applications from different devices is supported in being displayed on a current device, so that a user can perform cross-device application management, and seamlessly use, on the current device, an application installed on another device.

According to a first aspect, a cross-device application control method is provided, and includes: A first device obtains application information of at least one first application of a second device from a first distributed database, where the first distributed database is in the first device, the first distributed database is capable of data synchronization with a second distributed database, the second distributed database is in the second device, and the application information includes at least one of an application name, an application icon, and an application type. The first device displays a first interface, where the first interface includes a second application of the second device, and the second application belongs to a subset of the first application. The first application may be a plurality of applications, the second application may be one or more applications, and the subset may be a universal set, that is, the second application is a part or all of the at least one first application.

According to the technical solutions of this application, an existing application does not need to be modified, and a list of applications from different devices is supported in being displayed on a current device, so that a user can perform cross-device application management, and seamlessly use, on the current device, an application installed on another device.

With reference to the first aspect, in some implementations of the first aspect, the method further includes: The first device receives a first operation from a user, where the first operation indicates the first device to display the second application of the second device.

With reference to the first aspect, in some implementations of the first aspect, the method further includes: The first device obtains a list of applications on the second device that are allowed to be shared and/or a list of applications on the second device that are forbidden to be shared, where the list of applications on the second device that are allowed to be shared and/or the list of applications on the second device that are forbidden to be shared are/is generated by the second device based on a second operation of the user. The first device filters the application information of the first application based on the list of applications on the second device that are allowed to be shared and/or the list of applications on the second device that are forbidden to be shared, to obtain the second application, where the second application belongs to the list of applications on the second device that are allowed to be shared. In this way, the list of applications that are allowed to be shared can be displayed on a receiving device (the first device) based on a user intention, to ensure data security of the user, so that the user can perform cross-device application management, and seamlessly use, on the current device, the application installed on the another device.

With reference to the first aspect, in some implementations of the first aspect, the method further includes: The first device obtains first information from the second device, where the first information includes projection data of a third application, the third application belongs to the second application, and the projection data of the third application includes a display policy for the third application. The first device displays a second interface based on the first information, where the second interface includes the third application, and the third application is capable of invoking a hardware capability of the first device. In this way, an application may be supported in directly using various hardware capabilities of the receiving device (the first device).

With reference to the first aspect, in some implementations of the first aspect, the method further includes: The first device receives a third operation from the user, where the third operation indicates the first device to display the third application of the second device.

With reference to the first aspect, in some implementations of the first aspect, the method further includes: The first device sends second information to the second device, where the second information includes application information of the third application and the hardware capability of the first device, and the second information is used by the second device to generate the first information. In this way, a display policy can be specified based on a hardware capability of the receiving device, to support the application in being adaptively displayed in a resolution of the device, and a device screen size and a layout of the device.

With reference to the first aspect, in some implementations of the first aspect, the method further includes: The first device receives a first control instruction from a third device, where the third device is a control device. In response to the first control instruction, the first device controls movement of a cursor on a display interface of the first device, or in response to the first control instruction, the first device controls sliding of a display interface of the first device.

With reference to the first aspect, in some implementations of the first aspect, the first control instruction is generated by the third device according to a second control instruction, and the second control instruction is generated by the third device based on a fourth operation of the user. In this way, a proper application control manner is selected based on a device control capability, cross-platform application control is supported, and a plurality of operation manners such as button operation and touch operation are supported.

According to a second aspect, a cross-device application control method is provided, and includes: A second device obtains application information of at least one first application, where the application information includes at least one of an application name, an application icon, and an application type. The second device stores the application information of the first application in a second distributed database, where the second distributed database is capable of data synchronization with a first distributed database, the second distributed database may be set in the second device, and the first distributed database is set in a first device.

According to the technical solutions of this application, an existing application does not need to be modified, and a list of applications from different devices is supported in being displayed on a current device, so that a user can perform cross-device application management, and seamlessly use, on the current device, an application installed on another device.

With reference to the second aspect, in some implementations of the second aspect, the method further includes: The second device receives a first operation from a user, where the first operation indicates the second device to store the application information of the first application in the second distributed database.

With reference to the second aspect, in some implementations of the second aspect, the method further includes: The second device receives a second operation from the user, where the second operation indicates the second device to generate a list of applications that are forbidden to be shared. The second device generates the list of applications that are forbidden to be shared, where the list of applications that are forbidden to be shared is used by the first device to filter the application information of the first application, to obtain a second application, the second application belongs to a subset of the first application, and the second application belongs to a list of applications on the second device that are allowed to be shared. The second device sends, to a server, the list of applications that are forbidden to be shared, and the first device may obtain, from the server, the list of applications that are forbidden to be shared.

With reference to the second aspect, in some implementations of the second aspect, the second device receives first information from the first device, where the first information includes application information of a third application and a hardware capability of the first device, and the third application belongs to the second application of the second device. The second device determines projection data of the third application, where the projection data of the third application includes a display policy for the third application. The second device sends second information to the first device, where the second information includes the projection data of the third application, and the third application is capable of invoking the hardware capability of the first device.

According to a third aspect, a cross-device application control method is provided, and includes: A third device receives a first operation from a user, and the third device generates a first control instruction based on the first operation. The third device generates a second control instruction based on a type of a first device and the first control instruction. The third device sends the second control instruction to the first device, where the first control instruction indicates movement of a cursor on a display interface of the first device, or the first control instruction indicates sliding of a display interface of the first device.

In the technical solutions of this application, a proper application control manner is selected based on a device control capability, cross-platform application control is supported, and a plurality of operation manners such as button operation and touch operation are supported.

According to a fourth aspect, an electronic device is provided, and includes: a transceiver module, configured to obtain application information of a first application of a second device from a first distributed database, where the first distributed database is in a first device, the first distributed database is capable of data synchronization with a second distributed database, the second distributed database is in the second device, and the application information includes at least one of an application name, an application icon, or an application type; and a processing module, configured to display a first interface, where the first interface includes a second application of the second device, and the second application belongs to a subset of the first application.

With reference to the fourth aspect, in some implementations of the fourth aspect, the transceiver module is further configured to receive a first operation from the user, where the first operation indicates the first device to display the second application of the second device.

With reference to the fourth aspect, in some implementations of the fourth aspect, the transceiver module is further configured to obtain a list of applications on the second device that are forbidden to be shared, where the list of applications on the second device that are forbidden to be shared is generated by the second device based on a second operation of the user; and the processing module is further configured to filter the application information of the first application based on the list of applications on the second device that are forbidden to be shared, to obtain the second application, where the second application belongs to a list of applications on the second device that are allowed to be shared.

With reference to the fourth aspect, in some implementations of the fourth aspect, the transceiver module is further configured to obtain first information from the second device, where the first information includes projection data of a third application, the third application belongs to the second application, and the projection data of the third application includes a display policy for the third application; and the processing module is further configured to display a second interface based on the first information, where the second interface includes the third application, and the third application is capable of invoking a hardware capability of the first device.

With reference to the fourth aspect, in some implementations of the fourth aspect, the transceiver module is further configured to receive a third operation from the user, where the third operation indicates the first device to display the third application of the second device.

With reference to the fourth aspect, in some implementations of the fourth aspect, the transceiver module is further configured to send second information to the second device, where the second information includes application information of the third application and the hardware capability of the first device, and the second information is used by the second device to generate the first information.

With reference to the fourth aspect, in some implementations of the fourth aspect, the transceiver module is further configured to receive a first control instruction from a third device, where the third device is a control device; and the processing module is further configured to: in response to the first control instruction, control movement of a cursor on a display interface of the first device, or control sliding of a display interface of the first device.

The first control instruction is generated by the third device according to the second control instruction, and the second control instruction is generated by the third device based on a fourth operation of the user.

According to a fifth aspect, an electronic device is provided, and includes: a transceiver module, configured to obtain application information of a first application, where the application information includes at least one of an application name, an application icon, and an application type; and a processing module, configured to store the application information of the first application in a first distributed database, where the first distributed database is capable of data synchronization with a second distributed database, the first distributed database may be set in a first device, and the second distributed database is set in a second device.

With reference to the fifth aspect, in some implementations of the fifth aspect, the transceiver module is further configured to receive a first operation from a user, where the first operation indicates the second device to store application information of a plurality of applications in the first distributed database.

With reference to the fifth aspect, in some implementations of the fifth aspect, the transceiver module is further configured to receive a second operation from the user, where the second operation indicates the second device to generate a list of applications that are forbidden to be shared; the second device generates the list of applications that are forbidden to be shared, where the list of applications that are forbidden to be shared is used by the first device to filter the application information of the first application, to obtain a second application, the second application belongs to a subset of the first application, and the second application belongs to a list of applications on the second device that are allowed to be shared; and the transceiver module is further configured to send the list of applications that are forbidden to be shared.

With reference to the fifth aspect, in some implementations of the fifth aspect, the transceiver module is further configured to receive first information from the first device, where the first information includes application information of a third application and a hardware capability of the first device, and the third application belongs to the second application of the second device; the processing module is configured to determine projection data of the third application, where the projection data of the third application includes a display policy for the first application; and the transceiver module is further configured to send second information to the first device, where the second information includes the projection data of the third application, and the third application is capable of invoking the hardware capability of the first device.

According to a sixth aspect, an electronic device is provided, and includes: a transceiver module, configured to receive a first operation from a user; and a processing module, configured to generate a first control instruction based on the first operation, and generate a second control instruction based on a type of the first device and the first control instruction. The transceiver module is further configured to send a second control instruction to a first device, where the first control instruction indicates movement of a cursor on a display interface of the first device, or the first control instruction indicates sliding of a display interface of the first device.

According to a seventh aspect, a chip is provided. The chip includes a processor and a data interface, and the processor reads, through the data interface, instructions stored in a memory, to perform the method in any one of the implementations of the first aspect to the third aspect.

Optionally, in an implementation, the chip further includes memory, and the memory stores the instructions. The processor is configured to execute the instructions stored in the memory. When the instructions are executed, the processor is configured to implement the method according to any one of the implementations of the first aspect to the third aspect.

According to an eighth aspect, a computer program storage medium is provided. The computer-readable medium stores program code, and when the computer program code is run on a computer, the computer is enabled to perform the method according to any one of the possible implementations of the first aspect to the third aspect.

According to a ninth aspect, a computer program product including instructions is provided. When the computer program product runs on a computer, the computer is enabled to perform the method according to any one of the implementations of the first aspect to the third aspect.

According to a tenth aspect, a terminal device is provided, including modules configured to perform any possible implementation of the first aspect to the third aspect.

According to an eleventh aspect, a communication apparatus is provided. The apparatus is configured to perform the method according to any one of the possible implementations of the first aspect to the third aspect.

According to a twelfth aspect, a communication apparatus is provided. The apparatus includes a processor and a memory. The processor is coupled to the memory, the memory is configured to store a computer program, and the processor is configured to execute the computer program stored in the memory, so that the communication apparatus performs the method according to any one of the possible implementations of the first aspect to the third aspect.

According to a thirteenth aspect, a communication apparatus is provided. The apparatus includes a processor, a memory, and a transceiver. The memory is configured to store a computer program, and the processor is configured to execute the computer program stored in the memory, so that the apparatus performs the method according to any one of the possible implementations of the first aspect to the third aspect.

According to a fourteenth aspect, a communication apparatus is provided. The communication apparatus includes at least one processor and a communication interface. The communication interface is used by the communication apparatus to exchange information with another communication apparatus, and when program instructions are executed by the at least one processor, the communication apparatus is enabled to implement the method according to any one of the possible implementations of the first aspect to the third aspect.

According to a fifteenth aspect, a processor is provided. The processor includes at least one circuit, configured to perform the method according to any one of the possible implementations of the first aspect to the third aspect.

According to a sixteenth aspect, a chip system is provided. The chip system includes at least one processor, and when program instructions are executed by the at least one processor, the chip system is enabled to implement the method according to any one of the possible implementations of the first aspect to the third aspect.

### BRIEF DESCRIPTION OF DRAWINGS

FIG. 1 is a schematic of two current methods for projection between devices;

FIG. 2 is a schematic of a current method for application relay between devices;

FIG. 3 shows a system architecture to which a cross-device application control method is applicable according to an embodiment of this application;

FIG. 4 shows three specific implementations according to this application;

FIG. 5 is a schematic of a hardware structure of an electronic device according to an embodiment of this application;

FIG. 6 is a schematic flowchart of a cross-device application control method according to an embodiment of this application;

FIG. 7 is a schematic flowchart of a specific example of a cross-device application control method according to an embodiment of this application;

FIG. 8 is a diagram of an architecture to which a specific example a cross-device application control method is applicable according to an embodiment of this application;

FIG. 9 is a diagram of a user interface of a specific example of a cross-device application control method according to an embodiment of this application;

FIG. 10 is a diagram of another user interface of a specific example of a cross-device application control method according to an embodiment of this application;

FIG. 11 is a schematic flowchart of another specific example of a cross-device application control method according to an embodiment of this application;

FIG. 12 is an interaction diagram of an example of a cross-device application control method according to an embodiment of this application;

FIG. 13 is a schematic flowchart of still another specific example of a cross-device application control method according to an embodiment of this application;

FIG. 14 is a diagram of a user interface of a specific example of a cross-device application control method according to an embodiment of this application; and

FIG. 15 is a diagram of another user interface of a specific example of a cross-device application control method according to an embodiment of this application.

### DESCRIPTION OF EMBODIMENTS

The following describes technical solutions of this application with reference to accompanying drawings.

Terms used in the following embodiments are merely intended to describe particular embodiments, but are not intended to limit this application. As used in the specification and the appended claims of this application, the singular expressions “a/an”, “one”, “said”, “the foregoing”, “the” and “this” are intended to include such expressions as “one or more”, unless otherwise clearly indicated in the context. It should be further understood that in the following embodiments of this application, “at least one” and “one or more” refer to one, two, or more. The term “and/or” is used for describing an association relationship between associated objects, and indicates that three relationships may exist. For example, A and/or B may represent: Only A exists, both A and B exist, and only B exists, where A and B may be singular or plural. A character “/” generally indicates an “or” relationship between associated objects before and after the character.

Reference like “one embodiment” or “some embodiments” described in this specification means that a particular characteristic, structure, or feature described with reference to one or more embodiments is included in the one or more embodiments of this application. Therefore, statements “in one embodiment”, “in some embodiments”, “in some other embodiments”, “in other embodiments”, and the like appear in different places in this specification do not necessarily refer to the same embodiment, but mean “one or more but not all embodiments”, unless otherwise specified in other ways. Terms “include”, “comprise”, “have”, and variations thereof all mean “including but not limited to”, unless otherwise specified.

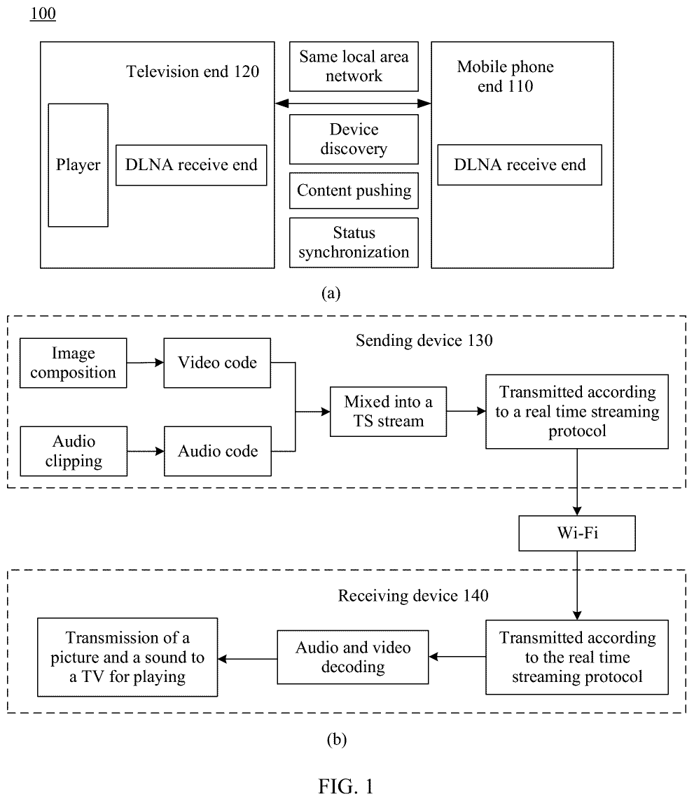

FIG. 1 is a schematic of two current methods for projection between devices.

Currently, mainstream methods for projection between devices mainly include a file-based projection method and a screen mirroring-based projection method. The file-based projection method is only applicable to pushing a file like a video, audio, or a picture to another device for display. For example, in a digital living network alliance (DLNA) protocol projection method shown in FIG. 1(a), a mobile phone end 110 and a television (TV) end 120 are in a same local area network, and perform device discovery, content pushing, status synchronization, and the like by using a DLNA receive end. However, the file-based projection method relatively relies on a projection capability of an application about providing related content. In addition, projection of another page of the application is not supported, and displayed content is limited. Therefore, a requirement of a user for using an application in a diversified manner cannot be met.

In the screen mirroring-based projection method, content displayed by a sending device can be sent to a receiving device for display in a mirroring manner, and the content displayed by the sending device is completely the same as that displayed by the receiving device. For example, in a mirroring projection Miracast protocol projection method shown in FIG. 1(b), a sending device 130 compresses a composite image into video code that complies with a digital video compression format standard H.264, compresses clipped audio into audio code that complies with an advanced audio coding (AAC) standard, mixes the image code and the audio code into a data transport stream (TS), and transmits the data transport stream to a receiving device 140 according to a real time streaming protocol (RTSP). The receiving device 140 receives the TS stream according to the RTSP protocol, performs audio and video decoding on the TS stream, and transmits a picture and a sound to a TV for playing. However, according to the screen mirroring-based projection method, a size of a display of the receiving device 140 and an operation cannot be adapted, and a user operation needs to be further controlled on the sending device 130. Therefore, interaction is complex.

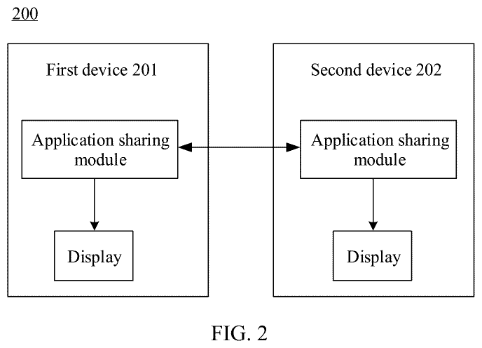

FIG. 2 is a schematic of a current method for application relay between devices.

As shown in FIG. 2, an application sharing module is disposed on both a first device 201 and a second device 202. The first device 201 and the second device 202 may perform application relay by using the application sharing modules, to implement a cross-device task processing function. The function allows a user to start a task on one device, and then continue to process the task on another nearby device. For example, the user may open a browser on the first device 201 to browse a web page, and a temporary browser tag appears on a left side of a taskbar on the second device 202 near the first device 201. If the user clicks the browser tag on the second device 202, the web page that is just browsed on the first device 201 may be opened. In this way, the browsing continues. However, in the foregoing method, a same application (for example, a same browser) needs to be installed on both the first device 201 and the second device 202. In this method, data content of the application is synchronized, and the application of the first device 201 cannot be migrated to the second device 202 for running. In addition, the user cannot actively select, on the second device 202, an application of the first device 201 to open for running, and needs to first operate the first device 201 for sharing, and then operate the second device 202 for receiving. Therefore, cross-device interaction is complex.

Based on the foregoing reasons, this application proposes a cross-device application control method and an electronic device. According to the method, an existing application does not need to be modified, and a list of applications from different devices is supported in being displayed on a current device, so that a user can perform cross-device application management, and seamlessly use, on the current device, an application installed on another device.

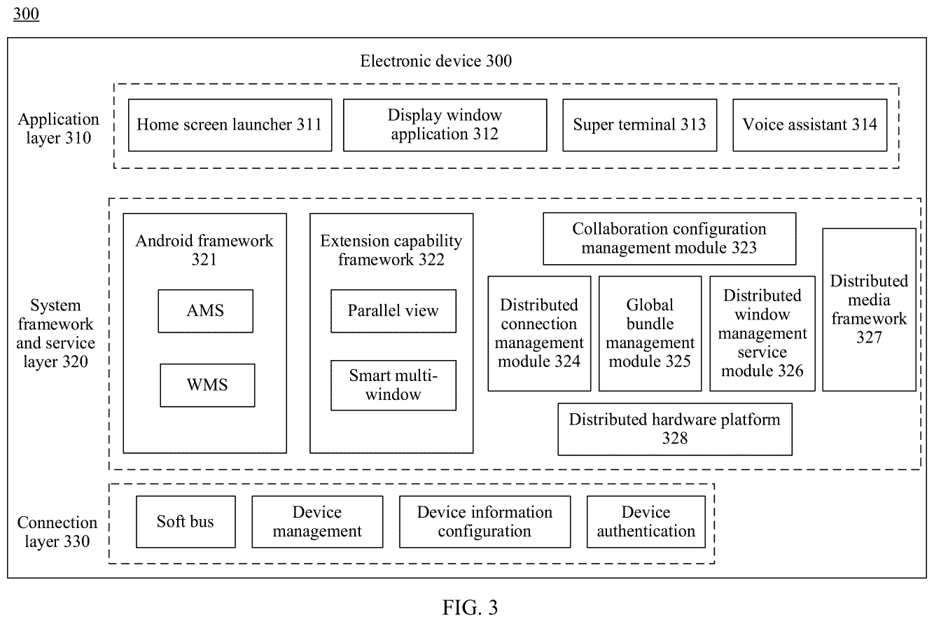

FIG. 3 shows a system architecture to which a cross-device application control method is applicable according to an embodiment of this application.

As shown in FIG. 3. A cross-device application control method provided in an embodiment of this application may be applied to an electronic device 300, and the electronic device 300 may be a sending device or a receiving device. The electronic device 300 includes an application layer 310, a system framework and service layer 320, and a connection layer 330. The application layer 310 includes a home screen launcher 311 (Launcher), a display window application 312 (HiWindow), a super terminal 313, and a voice assistant 314. The home screen launcher 311 is configured to display a super home screen widget and a user interface (UI). The display window application 312 is configured to display an application on a sending device side. The super terminal 313 is configured to provide a capability of interaction between a user and the system framework and service layer 320 and the connection layer 330. The voice assistant 314 is configured to provide a voice cross-end collaborative response, a capability of collaboratively opening an application, and the like. The system framework and service layer 320 includes an Android framework 321, an extension capability framework 322, a collaboration configuration management module 323, a distributed connection management module 324 (All Connect), a global bundle management (BMS) module 325, a distributed window management service (DWMS) module 326, a distributed media framework 327, and a distributed hardware platform 328. The Android framework 321 is configured to provide an application widget management service (AMS) function and a window management service (WMS) function. The extension capability framework 322 is configured to provide a parallel view function and a smart multi-window function. The parallel view function supports an application in being opened in a parallel view manner. The smart multi-window function supports multi-window display of an application. The collaboration configuration management module 323 is configured to manage a policy of cross-device application migration and a policy of hardware migration. The distributed connection management module 324 is configured to manage a distributed service state and process a service conflict. The global bundle management module 325 is configured to synchronize application list data, including application names and icons, of all devices across devices. The distributed window management service module 326 is configured to provide an application projection interface capability, window display adaptation logic, architecture reconstruction, and the like. The distributed media framework 327 is configured to support multi-channel audio, audio distributed capability, cross-device camera capability construction, and the like. The distributed hardware platform 328 is for hardware virtualization and application projection capability. The connection layer 330 is configured to provide a software bus function, and provide functions of device discovery, device authentication, device information configuration, device management, and the like.

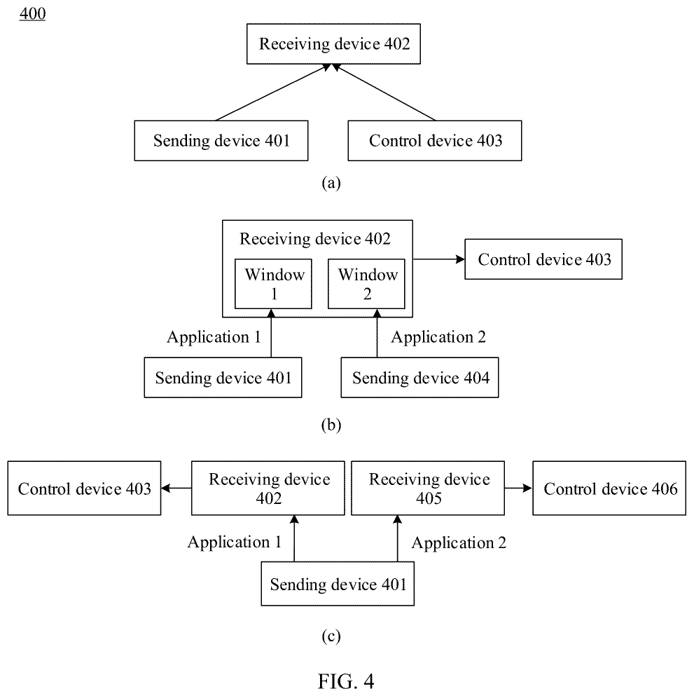

FIG. 4 shows three specific implementations according to this application. With reference to FIG. 4, the three specific implementations provided in this application are described. Benefiting from guidance and inspiration presented in the foregoing descriptions and related accompanying drawings, a person skilled in the art can make modifications and other embodiments of this application. Therefore, it should be understood that this application is not limited to the disclosed specific embodiments.

This application supports a user in seamlessly accessing, on a receiving device, an application of a sending device. The sending device may be a mobile phone of the user, and the application runs on the mobile phone. The sending device may be connected to the receiving device in a wireless manner, and send information such as an application icon, an application name, and a bundle name to the receiving device. The receiving device may be a large display screen. When the application is displayed on the large display screen, an application interface supports adaptation to a screen of the receiving device, supports landscape display, portrait display, split-screen display, and another display manner, supports application management, supports blocklist and trustlist control, and the like. A control device may be a remote control panel or a mobile phone, and is responsible for application control, and supports a plurality of interaction manners such as button interaction, touch interaction, and sliding interaction.

In a possible implementation, according to this application, that one sending device corresponds to one receiving device and that the receiving device corresponds to one control device may be supported. As shown in FIG. 4(a), a sending device 401 corresponds to a receiving device 402. A user may seamlessly access an application of the sending device 401 on the receiving device 402, and control, by using a control device 403 corresponding to the receiving device 402, the application displayed on the receiving device 402.

In another possible implementation, according to this application, that a plurality of sending devices correspond to one receiving device and that the receiving device corresponds to one control device may alternatively be supported. As shown in FIG. 4(b), both a sending device 401 and a sending device 404 correspond to a receiving device 402. A user may simultaneously access, on the receiving device 402, an application 1 (for example, a video application) of the sending device 401 and an application 2 (for example, a navigation application) of the sending device 404. The application 1 of the sending device 401 is displayed on a window 1 of the receiving device 402, and the application 2 of the sending device 404 is displayed on a window 2 of the receiving device 402. The user may control, by using a control device 403 corresponding to the receiving device 402, the application 1 and/or the application 2 displayed on the receiving device 402.

In still another possible implementation, according to this application, that one sending device corresponds to a plurality of receiving devices and that one receiving device corresponds to one control device may alternatively be supported. As shown in FIG. 4(c), a sending device 401 corresponds to both a receiving device 402 and a receiving device 405. A user may access, on the receiving device 402, an application 1 (for example, a video application) of the sending device 401, and control, by using a control device 403, the application 1 displayed on the receiving device 402. The user may access, on the receiving device 405, an application 2 (for example, a navigation application) of the sending device 401, and control, by using a control device 406, the application 2 displayed on the receiving device 405.

It should be understood that in the foregoing three implementations, an example in which one receiving device corresponds to one control device is used for description. However, this application is not limited thereto. A person skilled in the art may understand that one receiving device may usually correspond to a plurality of control devices. For example, when the receiving device 402 is a television display, the control device 403 may be a remote control, or may be a physical button on the television. With the development of television display technologies, the control device 403 may even be a touch panel.

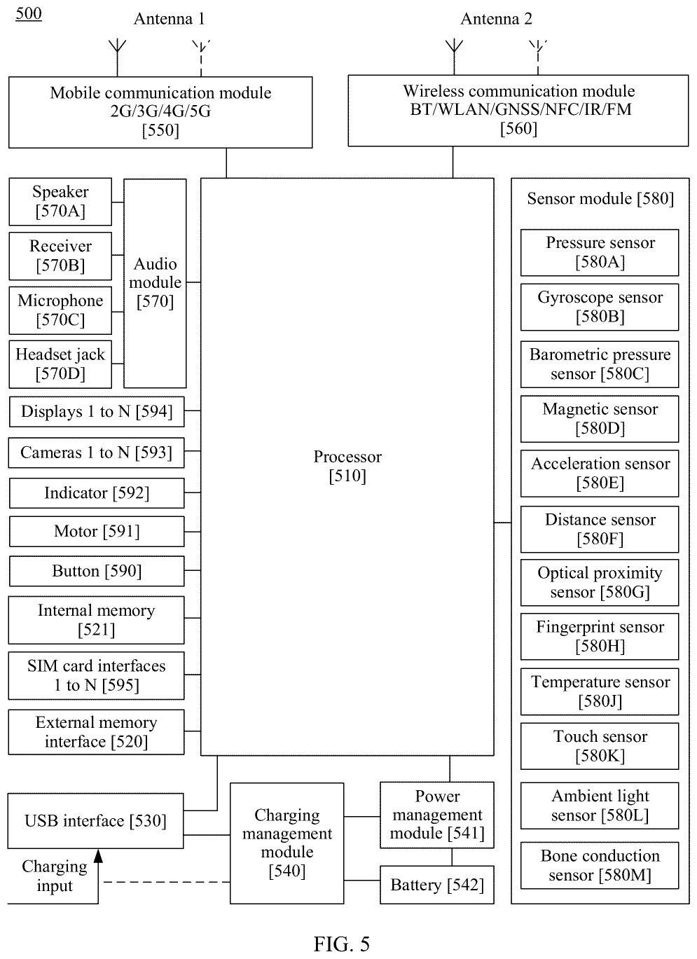

FIG. 5 is a schematic of a hardware structure of an electronic device according to an embodiment of this application. The electronic device 500 shown in FIG. 5 is merely an example, and the electronic device 500 may have more or fewer components than those shown in the figure, or two or more components may be combined, or there may be a different component configuration. Various components shown in the figure may be implemented in hardware, software, or a combination of hardware and software that includes one or more signal processing and/or application-specific integrated circuits.

The electronic device 500 may include a processor 510, an external memory interface 520, an internal memory 521, a universal serial bus (USB) interface 530, a charging management module 540, a power management module 541, a battery 542, an antenna 1, an antenna 2, a mobile communication module 550, a wireless communication module 560, an audio module 570, a speaker 570A, a receiver 570B, a microphone 570C, a headset jack 570D, a sensor module 580, a button 590, a motor 591, an indicator 592, a camera 593, a display 594, a subscriber identification module (SIM) card interface 595, and the like. The sensor module 580 may include a pressure sensor 580A, a gyroscope sensor 580B, a barometric pressure sensor 580C, a magnetic sensor 580D, an acceleration sensor 580E, a distance sensor 580F, an optical proximity sensor 580G, a fingerprint sensor 580H, a temperature sensor 580J, a touch sensor 580K, an ambient light sensor 580L, a bone conduction sensor 580M, and the like.

The processor 510 may include one or more processing units. For example, the processor 510 may include an application processor (AP), a modem processor, a graphics processing unit (GPU), an image signal processor (ISP), a controller, a video codec, a digital signal processor (DSP), a baseband processor, a neural-network processing unit (NPU), and/or the like. Different processing units may be independent devices, or may be integrated into one or more processors. In some embodiments, the electronic device 500 may alternatively include one or more processors 510. The controller may generate an operation control signal based on an instruction operation code and a time sequence signal, to control instruction reading and instruction execution. In some other embodiments, a memory may be further disposed in the processor 510, and is configured to store instructions and data. For example, the memory in the processor 510 may be a cache. The memory may store an instruction or data just used or repeatedly used by the processor 510. If the processor 510 needs to use the instruction or the data again, the processor 510 may directly invoke the instruction or the data from the memory. In this way, repeated access is avoided, waiting time of the processor 510 is reduced, and efficiency of processing data or executing instructions by the electronic device 500 is improved.

In some embodiments, the processor 510 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a SIM card interface, a USB interface, and/or the like. The USB interface is an interface that conforms to a USB standard specification, and may be specifically a mini USB interface, a micro USB interface, a USB Type C interface, or the like. The USB interface may be configured to connect to a charger to charge the electronic device 500, or may be configured to transmit data between the electronic device 500 and a peripheral device. The USB interface may alternatively be configured to connect to a headset, and play audio through the headset.

It may be understood that an interface connection relationship between the modules shown in this embodiment of this application is merely an example for description, and does not constitute a limitation on the structure of the electronic device 500. In some other embodiments of this application, the electronic device 500 may alternatively use an interface connection manner different from an interface connection manner in this embodiment, or use a combination of a plurality of interface connection manners.

A wireless communication function of the electronic device 500 may be implemented through the antenna 1, the antenna 2, the mobile communication module 550, the wireless communication module 560, the modem processor, the baseband processor, and the like.

The antenna 1 and the antenna 2 are configured to transmit and receive an electromagnetic wave signal. Each antenna in the electronic device 500 may be configured to cover one or more communication frequency bands. Different antennas may further be multiplexed to improve antenna utilization. For example, the antenna 1 may be multiplexed as a diversity antenna in a wireless local area network. In some other embodiments, the antenna may be used in combination with a tuning switch.

The mobile communication module 550 may provide a wireless communication solution that includes 2G/3G/4G/5G or the like and that is applied to the electronic device 500. The mobile communication module 550 may include at least one filter, a switch, a power amplifier, a low noise amplifier (LNA), and the like. The mobile communication module 550 may receive an electromagnetic wave through the antenna 1, perform processing such as filtering or amplification on the received electromagnetic wave, and transmit a processed electromagnetic wave to the modem processor for demodulation. The mobile communication module 550 may further amplify a signal modulated by the modem processor, and convert, through the antenna 1, the signal into an electromagnetic wave for radiation. In some embodiments, at least some functional modules of the mobile communication module 550 may be disposed in the processor 510. In some embodiments, at least some functional modules of the mobile communication module 550 may be disposed in a same device as at least some modules of the processor 510.

The wireless communication module 560 may provide a wireless communication solution that is applied to the electronic device 500 and that includes a wireless local area network (WLAN) (for example, a wireless fidelity (Wi-Fi) network), Bluetooth (BT), a global navigation satellite system (GNSS), frequency modulation (FM), a near field communication (NFC) technology, and an infrared (IR) technology. The wireless communication module 560 may be one or more components integrating at least one communication processing module. The wireless communication module 560 receives an electromagnetic wave through the antenna 2, performs frequency modulation and filtering processing on an electromagnetic wave signal, and sends a processed signal to the processor 510. The wireless communication module 560 may further receive a to-be-sent signal from the processor 510, perform frequency modulation and amplification on the to-be-sent signal, and convert, through the antenna 2, the signal into an electromagnetic wave for radiation.

The electronic device 500 implements a display function by using the GPU, the display 594, the application processor, and the like. The GPU is an image processing microprocessor and connects the display 594 to the application processor. The GPU is configured to perform mathematical and geometric calculations, and is configured for image rendering. The processor 510 may include one or more GPUs, and the GPUs execute program instructions to generate or change display information.

The display 594 is configured to display an image, a video, and the like. The display 594 includes a display panel. In some embodiments, the electronic device 500 may include one or N displays 594, where N is a positive integer greater than 1.

The electronic device 500 can implement a photographing function by using the ISP, the camera 593, the video codec, the GPU, the display 594, the application processor, and the like. The camera 593 is configured to capture a static image or a video. An optical image of an object is generated through a lens, and is projected to a photosensitive element. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into a standard image signal of a format like RGB or YUV. In some embodiments, the electronic device 500 may include one or N cameras 593, where N is a positive integer greater than 1.

The speaker 570A, also referred to as a “horn”, is configured to convert an audio electrical signal into a sound signal. The electronic device 500 may be used to listen to music or answer a hands-free call through the speaker 570A.

The microphone 570C, also referred to as a “mike” or a “mic”, is configured to convert a sound signal into an electrical signal. When making a call or sending voice information, a user may make a sound near the microphone 570C through the mouth of the user, to input a sound signal to the microphone 570C. At least one microphone 570C may be disposed in the electronic device 500. In some other embodiments, two microphones 570C may be disposed in the electronic device 500, to collect a sound signal and further implement a noise reduction function. In some other embodiments, three, four, or more microphones 570C may alternatively be disposed in the electronic device 500, to collect a sound signal, implement noise reduction, identify a sound source, implement a directional recording function, and the like.

In some embodiments, the electronic device may be a portable electronic device that further includes other functions such as a personal digital assistant function and/or a music player function, for example, a mobile phone, a tablet computer, a wearable electronic device having a wireless communication function (for example, a smart watch), a video player, a headset, a sound box, or a camera. An example embodiment of the portable electronic device includes but is not limited to a portable electronic device using iOS®, Android®, Microsoft®, or another operating system. The portable electronic device may alternatively be another portable electronic device, for example a laptop (laptop) or the like. It should be further understood that, in some other embodiments, the foregoing electronic device may not be a portable electronic device but a desktop computer, a television, a sound box, a camera, or the like.

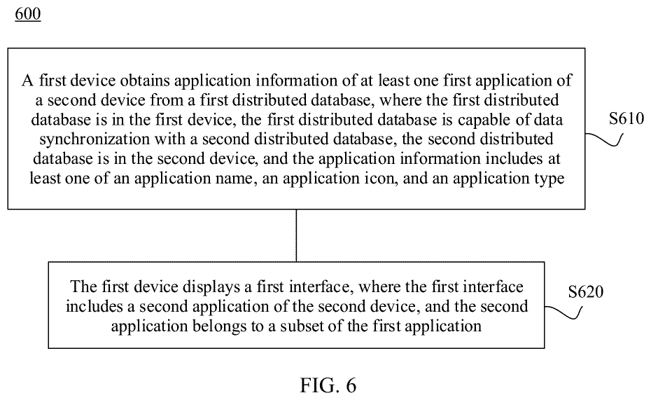

FIG. 6 is a schematic flowchart of an example of a cross-device application control method according to an embodiment of this application.

S610: A first device obtains application information of at least one first application of a second device from a first distributed database, where the first distributed database is in the first device, the first distributed database is capable of data synchronization with a second distributed database, the second distributed database is in the second device, and the application information includes at least one of an application name, an application icon, and an application type.

The first device may be a device having an application receiving capability, for example, a large screen, a cockpit, or a display. The second device may be a device having an application sharing capability, for example, a mobile phone. The first application may include a plurality of applications.

S620: The first device displays a first interface, where the first interface includes a second application of the second device, and the second application belongs to a subset of the first application.

Alternatively, the subset may be a universal set, and the second application may include a plurality of applications. In this way, the first interface may specifically display a list of applications of the second application.

Optionally, the method further includes: The first device receives a first operation from a user, where the first operation indicates the first device to display the second application of the second device.

By way of example, and not limitation, the first operation may be that the user logs in to a first account on the first device, and the first account is an account logged in to by the user on the second device. Alternatively, the first operation may be that the user displays a two-dimensional code of the first device on the first device, and scans the two-dimensional code of the first device by using the second device. When the first device is a cockpit of a vehicle, the first operation may be that the user gets on the cockpit of the vehicle, that is, gets on a driver seat of the vehicle.

Optionally, the method further includes: The first device obtains a list of applications on the second device that are allowed to be shared and/or a list of applications on the second device that are forbidden to be shared, where the list of applications on the second device that are allowed to be shared and/or the list of applications on the second device that are forbidden to be shared are/is generated by the second device based on a second operation of the user. The first device filters the application information of the first application based on the list of applications on the second device that are allowed to be shared and/or the list of applications on the second device that are forbidden to be shared, to obtain the second application, where the second application belongs to the list of applications on the second device that are allowed to be shared. The first device may obtain, from a server, the list of applications on the second device that are allowed to be shared and/or the list of applications on the second device that are forbidden to be shared. In this way, the list of applications that are allowed to be shared can be displayed on a receiving device (the first device) based on a user intention, to ensure data security of the user, so that the user can perform cross-device application management, and seamlessly use, on a current device, an application installed on another device.

Optionally, the method further includes: The first device obtains first information from the second device, where the first information includes projection data of a third application, the third application belongs to the second application, and the projection data of the third application includes a display policy for the third application. The first device displays a second interface based on the first information, where the second interface includes the third application, and the third application is capable of invoking a hardware capability of the first device. In this way, an application may be supported in directly using various hardware capabilities of the receiving device (the first device).

Optionally, the method further includes: The first device receives a third operation from the user, where the third operation indicates the first device to display the third application of the second device.

Optionally, the method further includes: The first device sends second information to the second device, where the second information includes application information of the third application and the hardware capability of the first device, and the second information is used by the second device to generate the first information. In this way, a display policy can be specified based on a hardware capability of the receiving device, to support the third application in being adaptively displayed in a resolution of the receiving device, and a device screen size and a layout of the receiving device.

Optionally, the method further includes: The first device receives a first control instruction from a third device, where the third device is a control device. In response to the first control instruction, the first device controls movement of a cursor on a display interface of the first device, or in response to the first control instruction, the first device controls sliding of a display interface of the first device.

Optionally, the first control instruction is generated by the third device according to a second control instruction, and the second control instruction is generated by the third device based on a fourth operation of the user. In this way, a proper application control manner is selected based on a device control capability, cross-platform application control is supported, and a plurality of operation manners such as button operation and touch operation are supported.

According to the technical solutions of this application, an existing application does not need to be modified, and a list of applications from different devices is supported in being displayed on a current device, so that the user can perform cross-device application management, and seamlessly use, on the current device, an application installed on another device.

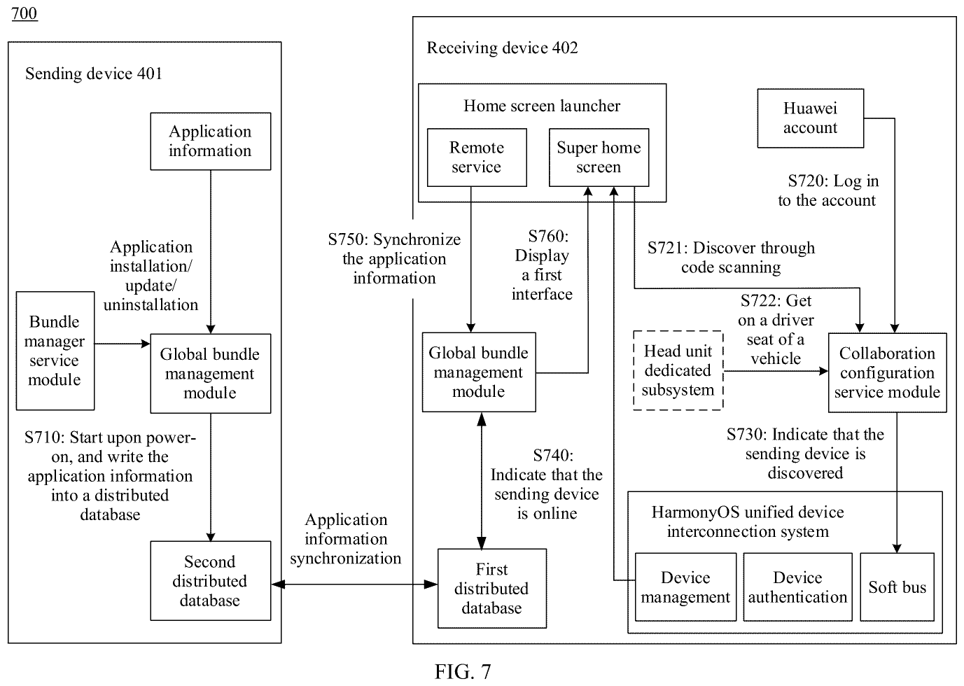

FIG. 7 is a schematic of a specific example of a cross-device application control method according to an embodiment of this application. A sending device 401 may be the second device in FIG. 6, and a receiving device 402 may be the first device in FIG. 6.

S710: The sending device 401 is started upon power-on, and writes application information into a second distributed database.

The sending device 401 may receive a first operation of a user, where the first operation indicates the sending device 401 to be started upon power-on. A global bundle management module of the sending device 401 may obtain application information, and store the application information in a distributed database. The application information includes full information of an application locally installed on the sending device 401, and the information includes but is not limited to a bundle name, an application name, an application icon, an application type, and the like. When the application information of the sending device 401 has update, for example, application installation, application update, or application uninstallation, the bundle management service module of the sending device 401 may send updated application information to the global bundle management module, and the global bundle management module stores the updated application information in the second distributed database.

The receiving device 402 may receive a second operation of the user, where the second operation indicates the receiving device 402 to display a list of applications on the sending device 401 that are allowed to be shared. The second operation may have the following cases:

### Case 1:

S720: The user logs in to an account on the receiving device 402.

The account logged in to by the user on the receiving device 402 and an account logged in to by the user on the sending device 401 are the same. Optionally, that the user logs in to an account on the receiving device 402 may further include: The user switches an account logged in to on the receiving device 402 to the account logged in to on the sending device 401.

### Case 2:

S721: The user uses the sending device 401 to scan a code, to discover the receiving device 402.

Specifically, the user may use the sending device 401 to scan a two-dimensional code identifier of the receiving device 402, to establish a connection to the receiving device 402.

### Case 3:

S722: The user gets on a driver seat of a vehicle in which the receiving device 402 is located.

In this case, the receiving device 402 may be a cockpit of the vehicle. The user may preset a sending device corresponding to the receiving device 402 (cockpit), for example, the sending device 401. When the user gets on the driver seat of the vehicle, a head unit dedicated subsystem of the receiving device 402 (cockpit) may notify a collaboration configuration service module of the receiving device 402 (cockpit) that the user gets on the driver seat of the vehicle, so that the receiving device 402 can discover that the sending device 401 preset by the user is online, and actively seeks to establish a connection to the sending device 401.

S730: The receiving device 402 invokes the collaboration configuration service module to notify a soft bus that the sending device 401 is discovered.

For example, the soft bus is in a HarmonyOS unified device interconnection system, and the system may further include a device management module and a device authentication module.

S740: The receiving device 402 invokes the device management module to notify a home screen launcher that the sending device 401 is online.

Specifically, the device management module of the receiving device 402 may send a notification to a super home screen in the home screen launcher, to indicate that the sending device 401 is online, and can synchronize application data.

S750: The receiving device 402 invokes a remote service module to start to synchronize the application information of the sending device 401.

Specifically, the remote service module of the receiving device 402 may invoke a global bundle management module interface to obtain the application information of the sending device 401 from a first distributed database. The application information of the sending device 401 is stored in the second distributed database, and the first distributed database is capable of data synchronization with the second distributed database.

S760: The receiving device 402 invokes the super home screen, to display a first interface.

Specifically, after the synchronization of the application information of the sending device 401 ends, the receiving device 402 invokes the super home screen to display the first interface, where the first interface includes the list of applications on the sending device 401 that are allowed to be shared. The super home screen may filter the obtained application information of the sending device 401 based on an application blocklist and an application trustlist (that is, a list of applications that are forbidden to be shared and the list of applications that are allowed to be shared) of the sending device 401, and finally display the list of applications on the sending device 401 that are allowed to be shared.

According to the technical solution provided in this application, an existing application does not need to be modified, and a list of applications from different devices is supported in being displayed on a current device, so that the user can perform cross-device application management, and seamlessly use, on the current device, an application installed on another device.

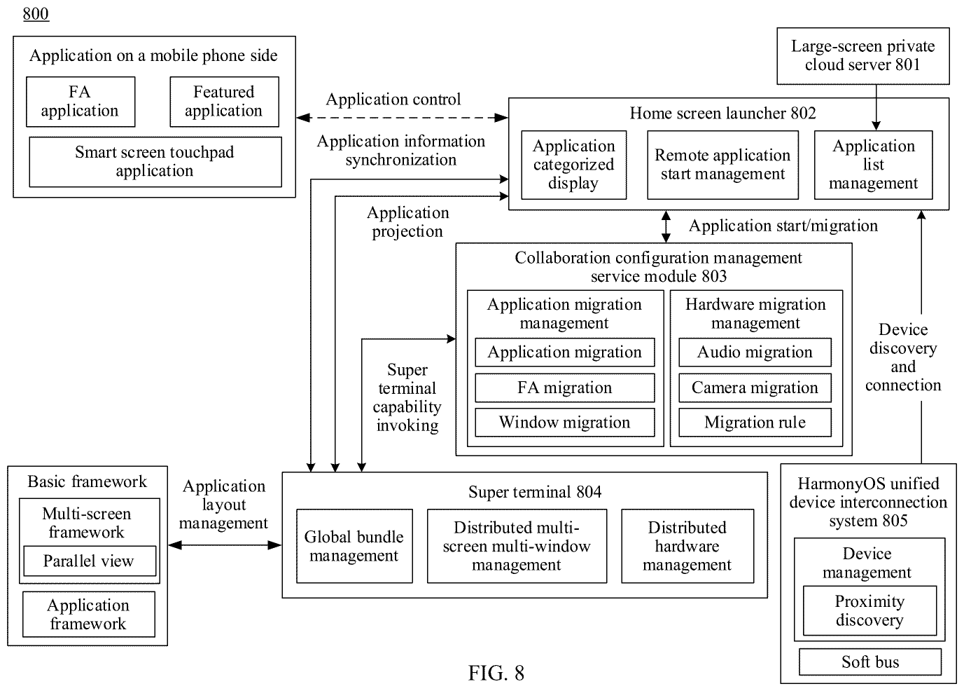

FIG. 8 is an overall architectural diagram of an example of a cross-device application control method according to an embodiment of this application. In FIG. 8, an example in which a receiving device is a large screen and a sending device is a mobile phone is used to show an architectural diagram provided in an embodiment of this application. The architectural diagram shown in FIG. 8 may be used to implement the method shown in FIG. 7.

As shown in FIG. 8, an architecture 800 includes a large-screen private cloud server 801, a home screen launcher 802, a collaboration configuration management service module 803, a super terminal 804, and a HarmonyOS unified device interconnection system 805. The home screen launcher 802 is located at an application layer of a system, and is responsible for connection and display of a super home screen. When a large screen is connected to a mobile phone, the home screen launcher 802 is used for synchronization and categorized display of a mobile phone application, and remote start and list management of the mobile phone application. The collaboration configuration management service module 803 is configured to provide a collaboration service atomization capability including an application migration management capability and a hardware migration management capability. The application migration management capability includes an application migration capability, a feature capability (feature ability, FA), migration capability, a window migration capability, and the like. The hardware migration management capability includes an audio migration capability, a camera migration capability, a migration rule, and the like. The super terminal 804 is configured to provide a global bundle management capability, a distributed multi-screen multi-window management capability, and a distributed hardware management capability. The global bundle management capability mainly includes a global bundle information synchronization capability, global bundle information includes information about an application, and the application may be an Android application, a HarmonyOS application, or the like. The distributed multi-screen multi-window management capability includes a window display adaptation capability that supports a mobile phone application in being displayed on the large screen device in a landscape mode, a parallel view mode, and a portrait mode. The HarmonyOS unified device interconnection system 805 includes a device management module and a soft bus. The device management module is configured to provide a capability of proximity discovery between devices, and the soft bus is configured to communicate between modules.

The home screen launcher 802 may communicate with the super terminal 804, to implement synchronization of application information and projection of an application on the home screen launcher 802. The home screen launcher 802 may further communicate with the HarmonyOS unified device interconnection system 805. When the HarmonyOS unified device interconnection system 805 discovers that the mobile phone is connected, the HarmonyOS unified device interconnection system 805 may notify the home screen launcher 802. The home screen launcher 802 may further obtain a blocklist and a trustlist of the mobile phone application from the cloud server 801, where the blocklist and the trustlist of the mobile phone application may be set by a user, and may alternatively be automatically generated by the system based on a type of a device (including a receiving device and a sending device). The home screen launcher 802 may further receive an operation of starting and migrating an application by a user, and invoke the collaboration configuration management service module 803 to implement application starting and migration. The collaboration configuration management service module 803 may make a decision on a collaboration policy based on a configurable collaboration rule, and invoke a distributed capability of the super terminal 804 to implement collaboration. Optionally, the application on the mobile phone side may include a smart screen touchpad application, and the application supports a touch operation of a mobile phone projection application and a touch operation of a large-screen application.

It should be understood that the foregoing solution may be implemented based on a HarmonyOS system. A HarmonyOS-based distributed interconnection technology supports device discovery, connection, and authentication, application data synchronization relies on a distributed data technology, application adaptation, application migration, and hardware migration capabilities rely on a collaboration configuration management service, and an application control capability relies on an adaptive application control service. Optionally, the method may be implemented based on another system, for example, iOS®, Android®, Microsoft®, or another operating system described above. This is not limited in this application.

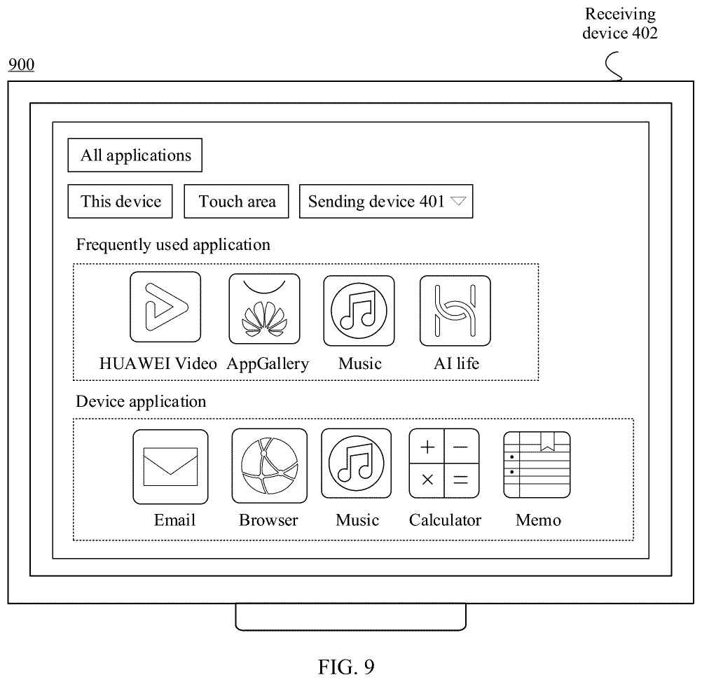

FIG. 9 is a diagram of a user interface of a specific example of a cross-device application control method according to an embodiment of this application.

As shown in FIG. 9, a receiving device 402 (for example, a large screen) may obtain, based on a user operation, application information of a sending device 401 (for example, the sending device 401 may be a mobile phone, and a model may be Mate 40), to display a first interface. The first interface includes a list of applications on the sending device 401 that are allowed to be shared. Specifically, a super home screen module in a home screen launcher of the receiving device 402 is responsible for displaying the application list of the sending device 401. The display interface supports an interface element layout. The first row may display a frequently used application. Optionally, the first row may display a maximum of M recently used applications. For example, there are four frequently used applications shown in the figure, that is, M is 4. It should be understood that a value of M may vary with a size of a page and an application icon. For example, M may be 5, 6, or 7. This is not limited in this application. The second row may display other application icons of the device. By way of example, and not limitation, application icons displayed in the second row may be arranged from A to Z based on initial letters of application names. When the application information of the sending device 401 changes, the first interface of the receiving device 402 is synchronously updated and displayed.

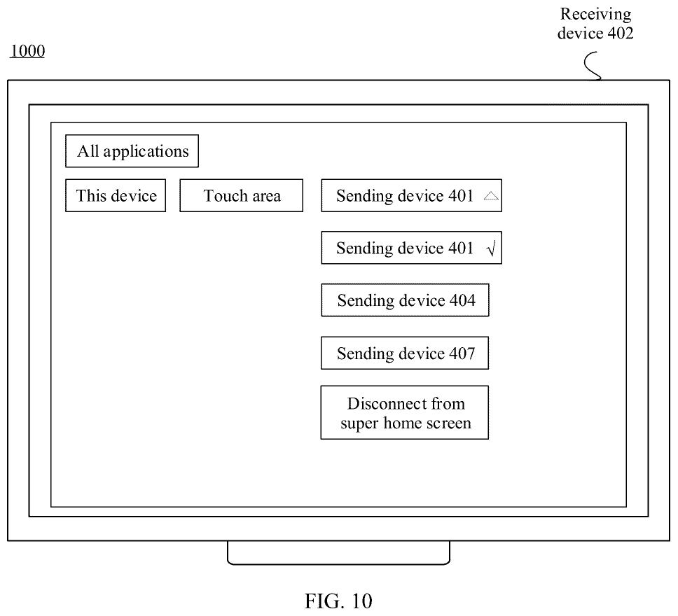

FIG. 10 is a diagram of another user interface of a specific example of a cross-device application control method according to an embodiment of this application.

As shown in FIG. 10, a receiving device 402 may be simultaneously connected to a plurality of sending devices, that is, there may be one or more sending devices 401. By way of example, and not limitation, a user may perform an operation on the receiving device 402 to switch the sending devices. For example, the user may tap an OK key on a keyboard tabulator key (tabulator key, Tab) on the receiving device 402, and a drop-down menu shown in FIG. 10 is displayed. The menu displays a list of sending devices that can be switched. The list may include a plurality of sending devices, for example, a sending device 401, a sending device 404, and a sending device 407. By way of example, and not limitation, models of the sending devices may be Mate 40, P50, Mate 30 Pro, or the like. After the user taps another sending device, the corresponding sending device may perform secondary confirmation, and the receiving device 402 may display a list of applications that are allowed to be shared and that are of the corresponding sending device.

It should be understood that, the foregoing describes the technical solutions of this application by using an example in which a model of the sending device is Mate 40, P50, or Mate 30 Pro, which should not be construed as a limitation on the technical solutions of this application. When the sending device is a device of another model or another vendor, the technical solutions of this application are also applicable.

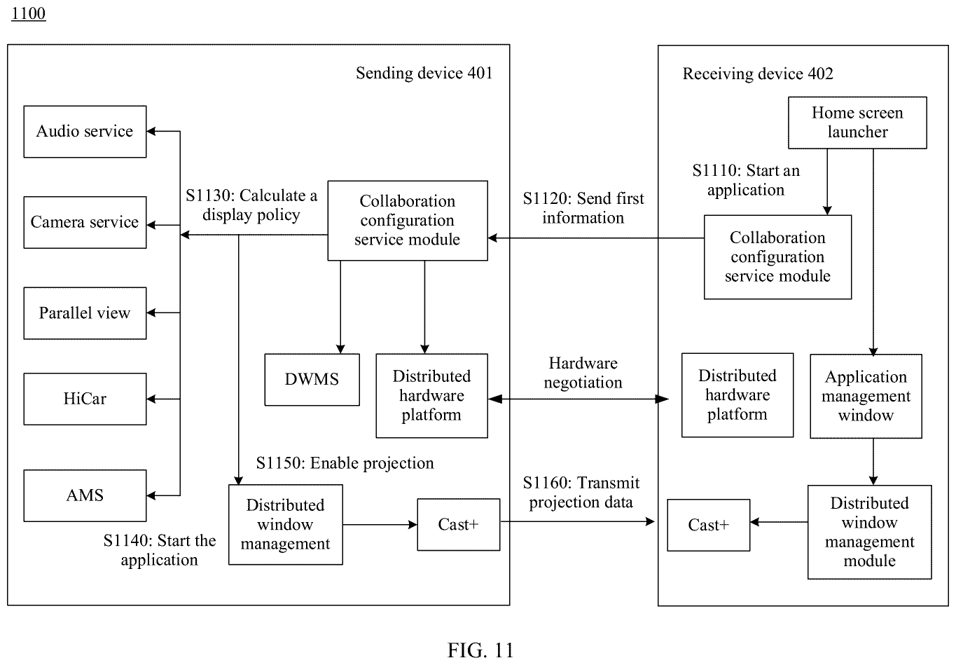

FIG. 11 is a schematic flowchart of another specific example of a cross-device application control method according to an embodiment of this application. The method may be performed after the method 700 shown in FIG. 7.

S1110: A user starts an application on a receiving device 402.

The user may start an application on a first interface displayed by the receiving device 402. The application may be one of applications on a sending device 401 that are allowed to be shared. For ease of description, the application may be referred to as a first application.

S1120: The receiving device 402 sends first information to the sending device 401.

The first information includes application information of the first application and a hardware capability of the receiving device 402. Hardware capabilities of a device include a microphone capability, a voice capability, and a camera capability of the device. Specifically, the receiving device 402 may invoke a collaboration configuration service module to send the first information to the sending device 401. The first information indicates a collaboration configuration service module of the sending device 401 to invoke a distributed window management service (DWMS) to create a virtual display (display), and indicates a distributed hardware platform of the sending device 401 to perform hardware negotiation with a distributed hardware platform of the receiving device 402, to obtain the hardware capability of the receiving device 402.

S1130: The sending device 401 calculates a display policy.

Specifically, the collaboration configuration service module of the sending device 401 calculates the display policy (for example, parallel view or landscape display) for the first application based on the first application and the hardware capability of the receiving device 402.

S1140: The sending device 401 starts the application.

Specifically, the collaboration configuration service module of the sending device 401 may invoke an AMS interface to start the first application, and send the first application to a virtual display for display.

S1150: The sending device 401 enables projection.

Specifically, the sending device 401 may invoke the distributed window management module to prepare to project the virtual display to the receiving device 402.

S1160: The sending device 401 sends projection data to the receiving device 402.

Specifically, the sending device 401 may send second information to the receiving device 402, where the second information includes the projection data of the first application, and the projection data of the first application includes the display policy that is for the first application and that is determined by the sending device 401 based on the first information. The receiving device 402 may display a second interface, where the second interface includes the first application, and the first application is capable of invoking the hardware capability of the receiving device 402. For example, when the receiving device is a large screen device, the application is supported in being displayed in a 4K resolution. When the receiving device is a tablet, the first application may be supported in being displayed in a 2K resolution. The first application may use a microphone of the receiving device to perform application recording, may use a sound box of the receiving device to perform voice playing, may use a camera to perform video recording, may use a global positioning system (GPS) to perform positioning, or the like.

According to the technical solutions provided in this application, an application of a sending device can be supported in being adaptively displayed in a resolution, a device screen size, and a layout of a receiving device, and further, the application of the sending device can be supported in directly using a hardware capability of the receiving device.

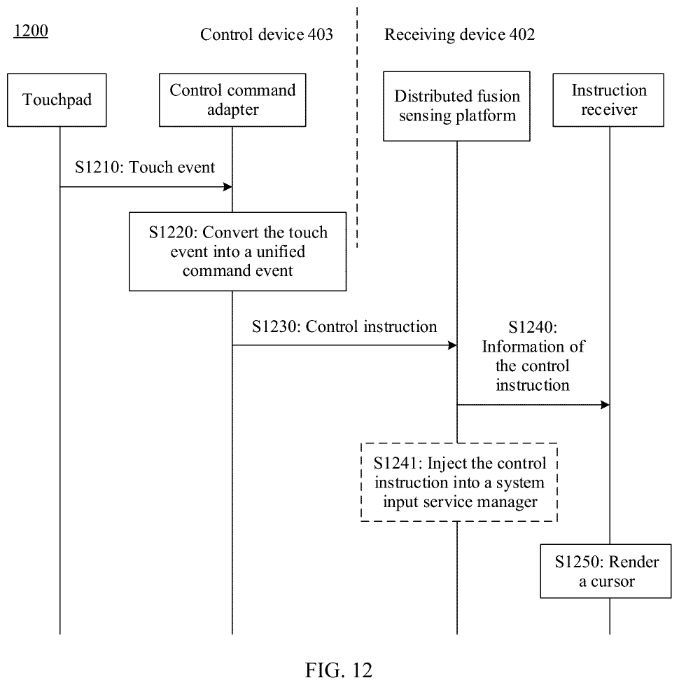

FIG. 12 is an interaction diagram of an example of a cross-device application control method according to an embodiment of this application. This embodiment outputs an example method for controlling, by a control device, an application that belongs to a sending device and is displayed on a receiving device. Applications on the sending device 401 and the receiving device 402 may be applications on different platforms, for example, a HarmonyOS application or an Android application. In addition, a command that can be obtained by the control device 403 is also related to the device platform. Therefore, control instructions supported by applications on different devices are completely different, and unified adaptation and conversion are needed.

S1210: A touchpad of the control device 403 sends a touch event to a control command adapter of the control device 403.

The control device 403 may generate a second control instruction (for example, a touch event) based on a third operation of a user on the touchpad. Optionally, when the control device 403 includes a physical button, the user may also perform the third operation on the physical button to generate the second control instruction (a button event).

S1220: The control device 403 converts the touch event into a unified command event.

Specifically, the control command adapter of the control device 403 converts the second control instruction (for example, the touch event) into a first control instruction (the unified command event) based on a type of the receiving device 402.

S1230: The control device 403 sends the control instruction to the receiving device 402.

Specifically, the control device 403 may send the converted first control instruction (the unified command event) to a distributed fusion sensing platform of the receiving device 402.

S1240: The receiving device 402 sends information of the control instruction to an instruction receiver.

The information of the control instruction includes parameters such as a type of the control instruction, a coordinate position of the control instruction, and a moving speed of the control instruction.

Optionally, the receiving device 402 may further perform S1241 to inject the control instruction into a system input service manager.

The distributed fusion sensing platform of the receiving device 402 obtains the first control instruction sent by the control device 403, and sends information of the first control instruction to the system input service manager. The system input service manager distributes the first control instruction to an upper-layer application for processing.

S1250: The instruction receiver of the receiving device 402 renders a cursor.

Specifically, the instruction receiver of the receiving device 402 renders the cursor based on the information of the first control instruction, and the rendered cursor is displayed on the receiving device 402.

According to the technical solutions of this application, a button event or a movement event of the user is converted on the control device, and adapted to a control instruction that should be executed by the receiving device, to support the user in performing cross-platform control on an application.

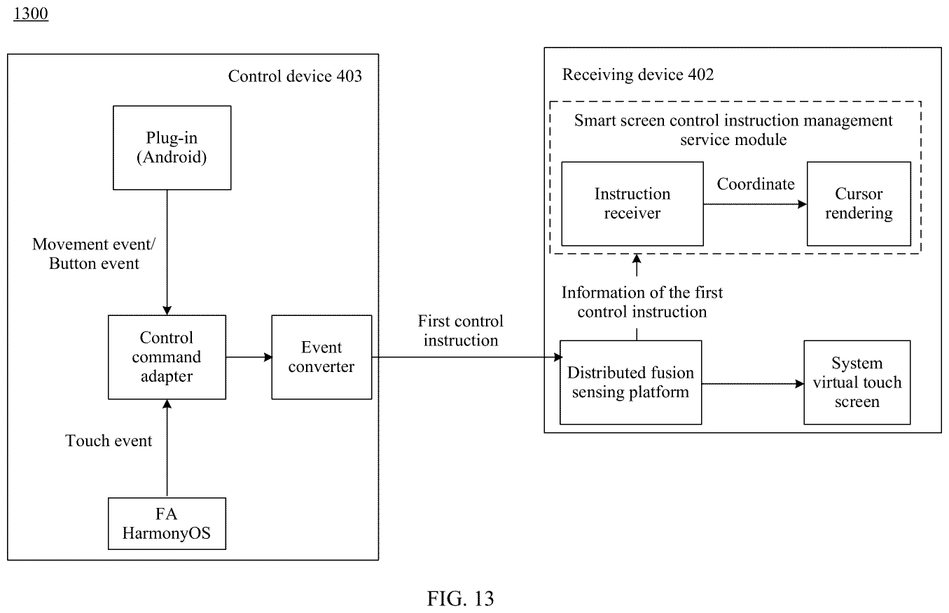

FIG. 13 is a schematic flowchart of still another specific example of a cross-device application control method according to an embodiment of this application. FIG. 13 shows the method in FIG. 12 through showing interaction between functional modules.

As shown in FIG. 13, in the control device 403, FA HarmonyOS may send a touch event to a control command adapter, and a plug-in of an Android system may also send a movement event/button event to the control command adapter. The control command adapter and the event converter convert the touch event, the movement event/button event, and the like (collectively referred to as a second control instruction) into a first control instruction (a unified command event). The receiving device 402 receives the first control instruction by using a distributed sensing platform, and transmits information of the first control instruction to a smart screen control instruction management service module. The smart screen control instruction management service module includes an instruction receiver. The instruction receiver renders a cursor based on the information of the first control instruction, and the rendered cursor is displayed on the receiving device 402.

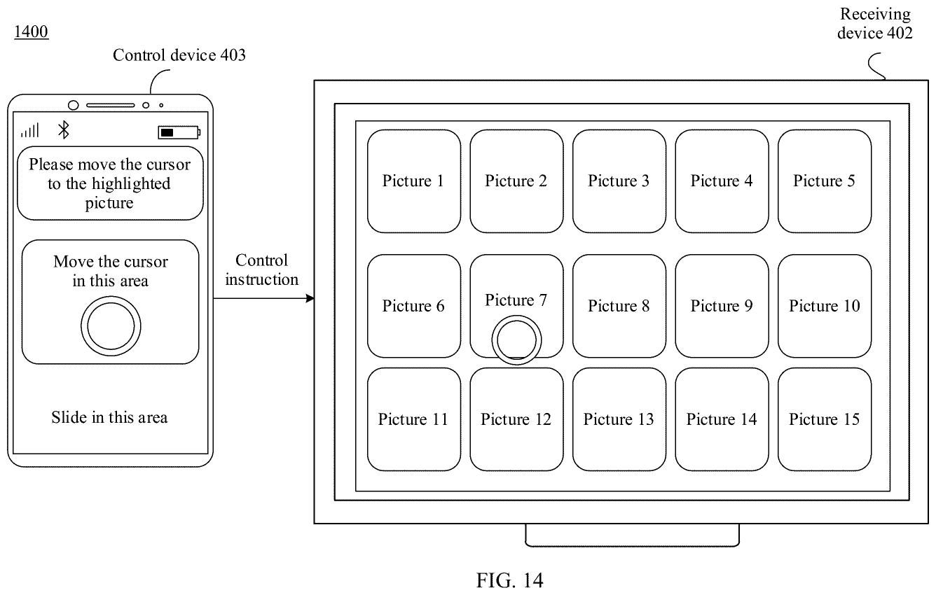

FIG. 14 is a diagram of a user interface of a specific example of a cross-device application control method according to an embodiment of this application. As shown in FIG. 14, the user may perform an operation in a specified area on the control device 403, and control the cursor displayed by the receiving device 402 to move to a highlighted picture (for example, a picture 7).

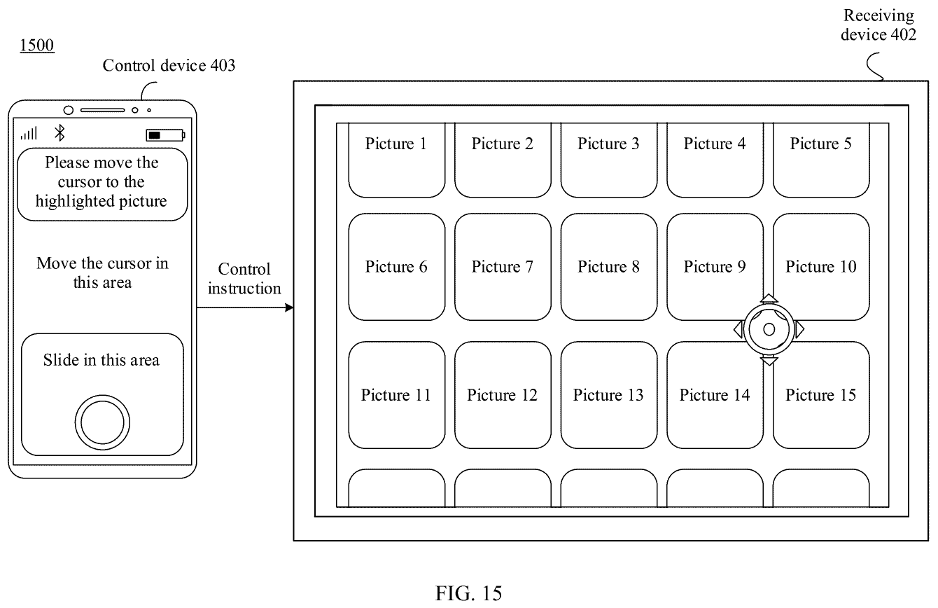

FIG. 15 is a diagram of another user interface of a specific example of a cross-device application control method according to an embodiment of this application. As shown in FIG. 15, the user may perform an operation in a specified area on the control device 403, and control an interface displayed by the receiving device 402 to slide up or down or slide left or right. By way of example, and not limitation, in response to an operation performed by the user in the specified area on the control device 403, an interface displayed by the receiving device 402 in FIG. 15 slides up relative to an interface displayed by the receiving device 402 in FIG. 14.

In embodiments provided in this application, it should be understood that the disclosed system, apparatus, and method may be implemented in other manners. For example, the foregoing apparatus embodiments are merely examples. For example, division of the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the current technology, or some of the technical solutions may be implemented in a form of a software product. The computer software product is stored in a storage medium, and includes several instructions for indicating a computer device (which may be a personal computer, a server, or a network device) to perform all or a part of the steps of the methods described in embodiments of this application. The storage medium includes any medium that can store program code, such as a USB flash drive, a removable hard disk, a read-only memory (ROM), a random access memory (RAM), a magnetic disk, or a compact disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A cross-device application control method, comprising:
obtaining, by a first device, application information of at least one first application of a second device from a first distributed database, wherein the first distributed database is in the first device, the first distributed database is capable of data synchronization with a second distributed database, the second distributed database is in the second device, and the application information includes at least one of an application name, an application icon, or an application type;
displaying, by the first device, a first interface, wherein the first interface includes a second application of the second device, and the second application belongs to a subset of the first application; and
receiving, by the first device, a first operation from a user, wherein the first operation indicates the first device to display the second application of the second device.

2. The method according to claim 1, further comprising:
obtaining, by the first device, a list of applications on the second device that are forbidden to be shared; and
filtering, by the first device, the application information of the first application based on the list of applications on the second device that are forbidden to be shared, to obtain the second application, wherein the second application belongs to a list of applications on the second device that are allowed to be shared.

3. The method according to claim 1, further comprising:
obtaining, by the first device, first information from the second device, wherein the first information comprises projection data of a third application, the third application belongs to the second application, and the projection data of the third application includes a display policy for the third application; and
displaying, by the first device, a second interface based on the first information, wherein the second interface includes the third application, and the third application is capable of invoking a hardware capability of the first device.

4. The method according to claim 3, further comprising:
receiving, by the first device, a third operation from the user, wherein the third operation indicates the first device to display the third application of the second device.

5. The method according to claim 3, further comprising:
sending, by the first device, second information to the second device, wherein the second information comprises application information of the third application and the hardware capability of the first device, and the second information is used by the second device to generate the first information.

6. The method according to claim 1, further comprising:
receiving, by the first device, a first control instruction from a third device, wherein the third device is a control device; and
controlling, by the first device in response to the first control instruction, movement of a cursor on a display interface of the first device, or
controlling, by the first device in response to the first control instruction, sliding of a display interface of the first device.

7. The method according to claim 2, further comprising:
receiving, by the first device, a first control instruction from a third device, wherein the third device is a control device; and
controlling, by the first device in response to the first control instruction, movement of a cursor on a display interface of the first device, or
controlling, by the first device in response to the first control instruction, sliding of a display interface of the first device.

8. The method according to claim 6, wherein the first control instruction is generated based on a second control instruction, and the second control instruction is generated based on a fourth operation of the user.

9. A cross-device application control method, comprising:
obtaining, by a second device, application information of at least one first application, wherein the application information includes at least one of an application name, an application icon, or an application type;
storing, by the second device, the application information of the first application in a second distributed database, wherein the second distributed database is capable of data synchronization with a first distributed database, the second distributed database is set in the second device, and the first distributed database is set in a first device; and
receiving, by the second device, a first operation from a user, wherein the first operation indicates the second device to store the application information of the first application in the second distributed database.

10. The method according to claim 9, further comprising:
receiving, by the second device, a second operation from the user, wherein the second operation indicates the second device to generate a list of applications that are forbidden to be shared;
generating, by the second device, the list of applications that are forbidden to be shared, wherein the list of applications that are forbidden to be shared is for the first device to filter the application information of the first application, to obtain a second application, the second application belongs to a subset of the first application, and the second application belongs to a list of applications on the second device that are allowed to be shared; and
sending, by the second device, the list of applications that are forbidden to be shared.

11. The method according to claim 9, further comprising:
receiving, by the second device, first information from the first device, wherein the first information comprises application information of a third application and a hardware capability of the first device, and the third application belongs to the second application of the second device;
determining, by the second device, projection data of the third application, wherein the projection data of the third application includes a display policy for the third application; and
sending, by the second device, second information to the first device, wherein the second information includes the projection data of the third application, and the third application is capable of invoking the hardware capability of the first device.

12. The method according to claim 10, further comprising:
receiving, by the second device, first information from the first device, wherein the first information comprises application information of a third application and a hardware capability of the first device, and the third application belongs to the second application of the second device;
determining, by the second device, projection data of the third application, wherein the projection data of the third application comprises a display policy for the third application; and
sending, by the second device, second information to the first device, wherein the second information includes the projection data of the third application, and the third application is capable of invoking the hardware capability of the first device.

13. A first electronic device, comprising:
one or more memory; and
one or more processors coupled to the one or more memory and configured to:
obtain application information of at least one first application of a second device from a first distributed database, wherein the first distributed database is in the first device, the first distributed database is capable of data synchronization with a second distributed database, the second distributed database is in the second device, and the application information includes at least one of an application name, an application icon, or an application type;
display a first interface, wherein the first interface includes a second application of the second device, and the second application belongs to a subset of the first application; and
receive a first operation from a user, wherein the first operation indicates the first device to display the second application of the second device.

14. The first electronic device according to claim 13, the one or more processors are further configured to:
obtain a list of applications on the second device that are forbidden to be shared; and
filter the application information of the first application based on the list of applications on the second device that are forbidden to be shared, to obtain the second application, wherein the second application belongs to a list of applications on the second device that are allowed to be shared.

15. The first electronic device according to claim 13, the one or more processors are further configured to:
obtain first information from the second device, wherein the first information comprises projection data of a third application, the third application belongs to the second application, and the projection data of the third application includes a display policy for the third application; and
display a second interface based on the first information, wherein the second interface includes the third application, and the third application is capable of invoking a hardware capability of the first device.

16. The first electronic device according to claim 15, the one or more processors are further configured to:
receive a third operation from the user, wherein the third operation indicates the first device to display the third application of the second device.

17. The first electronic device according to claim 15, the one or more processors are further configured to:
send second information to the second device, wherein the second information includes application information of the third application and the hardware capability of the first device, and the second information is for the second device to generate the first information.

18. The first electronic device according to claim 13, the one or more processors are further configured to:
receive a first control instruction from a third device, wherein the third device is a control device; and
control in response to the first control instruction, movement of a cursor on a display interface of the first device, or
control in response to the first control instruction, sliding of a display interface of the first device.

19. The first electronic device according to claim 14, the one or more processors are further configured to:
receive a first control instruction from a third device, wherein the third device is a control device; and
control in response to the first control instruction, movement of a cursor on a display interface of the first device, or
control in response to the first control instruction, sliding of a display interface of the first device.

20. The first electronic device according to claim 18, wherein the first control instruction is generated based on a second control instruction, and the second control instruction is generated based on a fourth operation of the user.
